(19) United States
(12) Patent Application Publication
(10) Pub. No.: US 2023/0008250 A1
(43) Pub. Date: Jan. 12, 2023

(54) Dental Device With Speech Recognition

(71) Applicant: Ivoclar Vivadent AG, Schaan (LI)

(72) Inventors: Michael Brotzge, Koblach (AT); Michael Tiefenthaler, Franstanz (AT); Johannes Matt, Mauren (LI); Robert Grünenfelder, Schaanwald (LI); Diego Gabathuler, Buchs (CH)

(21) Appl. No.: 17/853,566

(22) Filed: Jun. 29, 2022

(30) Foreign Application Priority Data
Jul. 1, 2021 (EP) 21183246.4
Jun. 28, 2022 (EP) 22181514.5

(51) Int. Cl. G10L 15/16; G10L 15/22; G10L 15/30

(52) U.S. Cl. CPC G10L 15/16; G10L 15/22; G10L 15/30; G10L 2015/221

(57) ABSTRACT

A dental device with a speech recognition module is provided, which is connected to a control device that controls at least part of the functions of the dental device. Based on the recognition result, the speech recognition module triggers a selected function of the dental device via the control device and has at least one microphone. An output module outputs information about the triggered function. The speech recognition module continuously listens via the microphone and has a code word module that activates or leaves active speech recognition for the temporally successive words when a code word is recognized and attempts to recognize them as predetermined control words each assigned to a function.

### CROSS-REFERENCE TO RELATED APPLICATIONS

This application claims priority to European patent application No. 21183246.4 filed on Jul. 1, 2021, and European patent application No. 22181514.5. filed on Jun. 28, 2022, which disclosures are incorporated herein by reference in their entirety.

### TECHNICAL FIELD

The invention relates to a dental device with a speech recognition module.

### BACKGROUND

An example of a dental device is a dental furnace or a dental milling machine.

Such dental devices typically have operating elements suitable for operation such as switches and buttons on the one hand and often a screen on the other. Instead of the screen, any suitable display elements such as LEDs are often used, but also loudspeakers, for example, to signal the end of a dental processing operation also acoustically.

Furthermore, it has become known to use a touch screen that can be used both for the input and for the output of data.

Users of dental devices are often manually involved elsewhere, so they do not have their hands available to operate the dental device.

In the case of such dental devices, it has therefore already been proposed to facilitate communication with the user.

From EP 2 368 513 A1 and corresponding US 20110238049 A1, which US published application is hereby incorporated by reference, it has become known to operate a control device for a soft tissue laser by voice input. Furthermore, a loudspeaker is provided, which indicates the set parameter combination by voice output.

In this solution, the voice input refers to the parameter(s) of the laser to be set, respectively, and the output is also limited to the parameters concerned.

U.S. Pat. Nos. 11,367,448, 11,367,438, 11,361,763, 20030232305, 20100100080, 20200411011, are directed to speech recognition devices and are hereby incorporated by reference in their entirety

### SUMMARY

Contrary to the solution discussed above, the invention is based on the task of creating a dental device with speech recognition according to the claims, the handling of which is simplified and whose acceptance is increased. Advantageous further developments result from the sub-claims.

According to the invention, it is provided to realize a special code word module. The microphone is part of the code word module and remains switched on during the operation of the dental device.

According to the invention, the code word module switches on the speech recognition module. The code word module unlocks the mapping of the following words for comparison with control words. Without such an unlocking the speech recognition module is not active. This ensures that words not recognized by the speech recognition module without a code word trigger the corresponding function of the dental device.

Furthermore, this opens up the possibility of significantly increasing the control words that trigger the same functions, without the risk of recognized control words triggering an undesirable function.

Thus, according to the invention, it is also possible to reduce the training time for the speech recognition module, or even to dispense with training if necessary.

This contributes significantly to increasing acceptance, especially when different users want to use the same dental device.

According to the invention, the words following the recognized code word are subjected to speech recognition, and this triggers a function of the dental device controlled by the control device when a word is recognized that is assigned to the relevant function.

For example, if a predetermined program is to be started, the “Start” function can be triggered by both the control word “Start” and the control word “Go”.

Furthermore, speech recognition can be set to be less critical, so that the recognition of the word “Start” is successful both when a male voice and when a female voice pronounces the word “Start”.

In an advantageous embodiment of the invention, it is provided to assign a number of control words to a command that triggers the function in question.

Preferably, this assignment is also carried out in the speech recognition module. The speech recognition module preferably is separate from the code word module. Also an integration is possible, e.g. both modules share the same microphone.

The code word module is preferably implemented on a small and separate single-board computer such as a Raspberry Pi. This is programmed to recognize only the given code word. This means that considerably less computing power is required, so that the single-board computer is sufficient.

When the dental unit is switched on and ready for operation, the code word module is also activated.

The speech recognition module, which is based on a more powerful microcomputer, is otherwise in sleep mode in this operating state, however. When the code word module recognizes the code word, it emits a trigger signal that puts the more powerful microcomputer into active mode. This happens within fractions of a second, for example within 0.1 seconds.

In the now available recognition mode, the speech recognition module listens and attempts to recognize control words in order to be able to trigger the desired function.

According to the invention, it is particularly advantageous that the code word module, like the speech recognition module, is in principle suitable for responding to acoustic signals. However, it has a significantly reduced range of functions and an equally seriously reduced vocabulary.

The sampling rate is low, so that the analog/digital converter of the code word module can be implemented with little effort and also consumes little energy. This aspect is particularly relevant if the dental device is designed as a handheld device with a battery or accumulator.

According to the invention, it is envisaged that the recognition rate and the recognition quality are also lower than for the speech recognition module. Investigations carried out in connection with the invention have shown that users readily accept that they may have to speak a code word several times until activation is successful.

The codeword module analyzes only a fraction of the available features of the output signal of its ND converter, but the particularly significant features.

Activation here means the activation and switching on of the speech recognition module.

In contrast, it is considered much more critical if errors occur during speech recognition or even malfunctions are triggered due to false recognition.

According to the invention, the speech recognition module and also the entire area of the dental device relating to it is switched off, so that no malfunction can be triggered as long as the code word is not recognized.

In an advantageous embodiment of the invention, the speech recognition module is turned off when a command that triggers a related function of the dental device has been recognized. This command may also be triggered by an interaction between the user and the dental device. Examples of this can be seen in the figure description. In this respect, setting a firing program of a dental furnace by consulting the dental furnace regarding the parameter values and voice input of the user, including starting the dental furnace with the selected firing program, may constitute a command.

When a control word is recognized, this is reproduced via an output module as a precaution. This is preferably done in such a way that the speech recognition module feeds the word to the control device, which then feeds the word to the output module.

Alternatively, it is also possible for the speech recognition module to feed the word directly to the output module.

In both cases, the output module outputs the word, preferably both via a display, i.e., visually, and via a loudspeaker.

The relevant function is preferably only triggered by the control device when:
Firstly, a predetermined time has elapsed without the user cancelling the selection of the function, or:
Secondly, the user actively confirms the function.

Such confirmation is preferably carried out via a touch screen.

It is understood that the division in two of the speech recognition module described above is not absolutely necessary. The recognition of the code word can also be done by the computer that comprises the actual speech recognition module.

Preferably, the microphone is part of the speech recognition module. This design offers the possibility of calibrating the microphone in advance to the optimal recognition.

However, it is also possible to use a separate microphone. This can also be connected to the speech recognition module only via a data connection. In this case, the microphone can be part of a smartphone and the digitized language can be transmitted to the speech recognition module via an app.

In a further modified embodiment, the app on the smartphone also includes speech recognition. The data connection between the smartphone and the dental device then allows the control device to be controlled, in a similar way to the integrated solution described above.

In a further preferred embodiment, the output module is also provided on the smartphone. This provides visual and or acoustic feedback directly in the user's attention area.

In a further modified embodiment compared with this, the speech recognition module is provided as an app and the output module is also provided as part of this app on the smartphone. In terms of computing power, a smartphone is easily capable of realizing speech recognition and even more so output.

Experience has shown that there is a high level of acceptance if the user can control the dental device via smartphone, especially if he does not even need his fingers to do so.

In a further modified embodiment, it is provided to externalize the computing power required for speech recognition.

In this embodiment, the dental device transmits the preferably digitized output signal of the microphone to an external computer. The external computer can be a desktop computer, a local server or even a cloud server.

This external computer then immediately transmits the signal to trigger the function recognized via control words.

In a further modified embodiment, it is provided that the user interacts with the dental device according to the invention. The interaction can consist of questions that the user asks the dental device and that the control device answers via its own AI module, or of a function triggered by the user and to be confirmed by him.

The AI module of the control device is fed by the output signal of the speech recognition module and is able to recognize from the recognized words a user question or, if necessary, a user command.

Based on this, it generates a response that is output either by voice output or by a display on a screen of the dental device.

It is also possible to recognize a user action that relates to the dental device via the AI module and initiate what is required.

An example of this is an order for consumables required by the dental device. For this case, the dental device is connected to the Internet and the user first says the code word and then, for example, the command “orders” and then specifies in more detail the consumable he needs. The recognition of the word “orders” causes the subsequent words to be interpreted not as control words for triggering functions of the dental device, but as consumables to be ordered.

The display module then displays the consumables to be ordered and waits for a confirmation from the user.

As soon as this confirmation is received, the order for the required consumables is placed via the Internet.

In an advantageous embodiment of the invention, it is provided that the output signal of the speech recognition module is fed to an AI module. The AI module is designed to understand the meaning of the recognized words and to trigger the required actions. There are three main types of actions that can be considered:

If the user speaks in complete sentences, the AI module tries to recognize whether a function of the dental device corresponds to the meaning of the sentence.

This is then either triggered or the triggering of the function is suggested to the user and the function is then executed after user confirmation.

If the recognized words indicate that the user is asking a question, the AI module attempts to provide an answer to the question based on the capabilities of artificial intelligence. This is then either output on the touchscreen or via speech synthesis through the dental device's loudspeakers. A third option is then to send the answer to the user's smartphone, which then outputs it.

If the AI module concludes from the recognized words that an order or other operation to be performed over the Internet is desired by the user, this operation is indicated to the user, either visually or acoustically. Upon user confirmation, the operation is then initiated.

In a further advantageous embodiment, it is provided that the AI module performs a logic check with respect to the recognized control words. As an example, consider the situation in a sintering furnace where the sintering process is not yet complete but the control words for opening the furnace hood are recognized.

The AI module has learned that premature opening will result in the dental restoration parts to be sintered becoming unusable and having to be discarded.

Therefore, opening in this situation is blocked and accordingly not executed. The user is informed of this, via the output module, that his command has been understood but has not been executed for the aforementioned reason.

Another example of an advantageous embodiment of the invention using the AI module is a collision check of future functions to be performed:

If, for example, a user has entered the command that a dental restoration part should be finished firing and cooled at 10 am the next day and, in addition, an administrator has set the regular cleaning firing to 8 am, the AI module shifts one of the colliding appointments so that there is no longer a collision. In the case described, the cleaning firing of the administrator is preferably postponed.

In a further advantageous embodiment, it is provided that when a body part of a user is detected, the control device outputs, via an output module, information about an executed function and/or a function to be executed. In this way, the action to be executed or the action being executed is clearly recognizable to the user, and operating safety is increased.

It is preferred that a dental device is provided as a dental furnace, a dental milling machine, a dental rapid prototyping device, a dental end-finishing device, a dental polishing device, a dental polymerization device, a dental CAD/CAM device, a dental extraction device, a dental mixer, a dental casting device, a dental press, a dental thermoforming device, a dental vibrator or other dental device, wherein the dental device comprises a speech recognition module, a control device, wherein the speech recognition module is connected to the control device, which control device controls at least a part of the functions of the dental device, at least one microphone in the speech recognition module, wherein the speech recognition module triggers a selected function of the dental device via the control device based on a recognition result, an output module connected to the control device that outputs information about the triggered function, wherein a code word module is provided which module continuously listens via the microphone, wherein the code word module activates or leaves active the speech recognition module for speech recognition of further words when a code word is recognized, and wherein the speech recognition module attempts to recognize the further words as predetermined control words or control commands each assigned to a function.

It is preferred that the speech recognition module is switched off or deactivated as long as the code word module has not recognized a code word.

It is preferred that the code word module has an analog/digital converter which operates with lower energy and/or lower sampling rate than an analog/digital converter of the speech recognition module.

It is preferred that the code word module is implemented separately from the speech recognition module and is switched on when the dental appliance is switched on, and wherein the speech recognition module is switched off as long as the code word module has not recognized a code word.

It is preferred that the speech recognition module is integrated into the dental device and is in electrical connection with the control device of the dental device.

It is preferred that the speech recognition module is spatially separated from the dental device and is or can be brought into data connection with the control device of the dental device.

It is preferred that the speech recognition module is connected to the output module that acoustically and/or visually reproduces the recognized word or words.

It is preferred that the speech recognition module is connected via an AI module to the output module, which acoustically and/or visually outputs responses to the recognized word or words, wherein the AI module is part of the control device or is realized in a cloud or other remote memory.

It is preferred that the speech recognition module is connected to the Internet via an AI module or the speech recognition module accesses the AI module via the Internet, and wherein the AI module or the speech recognition module or the control device triggers an action or an order, based on the recognized word or words.

It is preferred that the speech recognition module is connected to the output module, which, based on the recognized word or words, acoustically or visually displays a selection of existing functions and prompts for selection from the selection of existing functions.

It is preferred that the control device outputs, acoustically and/or visually, via the output module, information about the function the control device performs and/or is to perform.

It is preferred that the control device outputs a selection or a question about functions executed and/or to be executed acoustically and/or visually via the output module and waits for a response from a user via the speech recognition module and triggers a function based on the recognized word or words.

It is preferred that the control device stores a function to be started in the future based on the word or words recognized by the speech recognition module and starts the function at the correct time.

It is preferred that the speech recognition module and/or the control device is connected by data connection to at least one other dental device having a control device.

It is preferred that a dental device is provided comprising a camera and an image recognition module connected to a control device that controls at least part of the functions of the dental device, an output module, a feedback device connected to the control device, wherein the image recognition module recognizes a picture taken by the camera and triggers a selected function of the dental device via the control device based on the received recognition result, and wherein the feedback device provides information about the triggered function via the output module.

It is preferred that the image recognition module continuously records and recognizes images via the camera and unlocks rights when recognizing a particular image.

It is preferred that the image recognition module activates or leaves active rights existing for a user to trigger functions of the dental device when recognizing a body part of the user.

It is preferred that the image recognition module allows a user to perform at least one function of the dental device to which the user is entitled by recognizing temporally successive images and/or wherein the speech recognition module allows a user to perform at least one function of the dental device to which the user is entitled by recognizing temporally successive words.

It is preferred that a method of activating a function of a dental device is provided, which method comprises the following steps: a code word module continuously listening via a microphone, the code word module activating or leaving active a speech recognition module for speech recognition of further words when a code word is recognized, the speech recognition module attempting to recognize the further words as predetermined control words or control commands each assigned to a function, the speech recognition module triggering a selected function of the dental device via a control device based on a recognition result, an output module connected to the control device outputting information about the triggered function.

It is preferred that a computer program product is provided that comprises program code which is stored on a non-transitory machine-readable medium, the machine-readable medium comprising computer instructions executable by a processor, which computer instructions cause the processor to perform the method set forth above.

### BRIEF DESCRIPTION OF THE INVENTION

Further advantages, details and features result from the following description of exemplary embodiments of a dental device according to the invention with reference to the drawings.

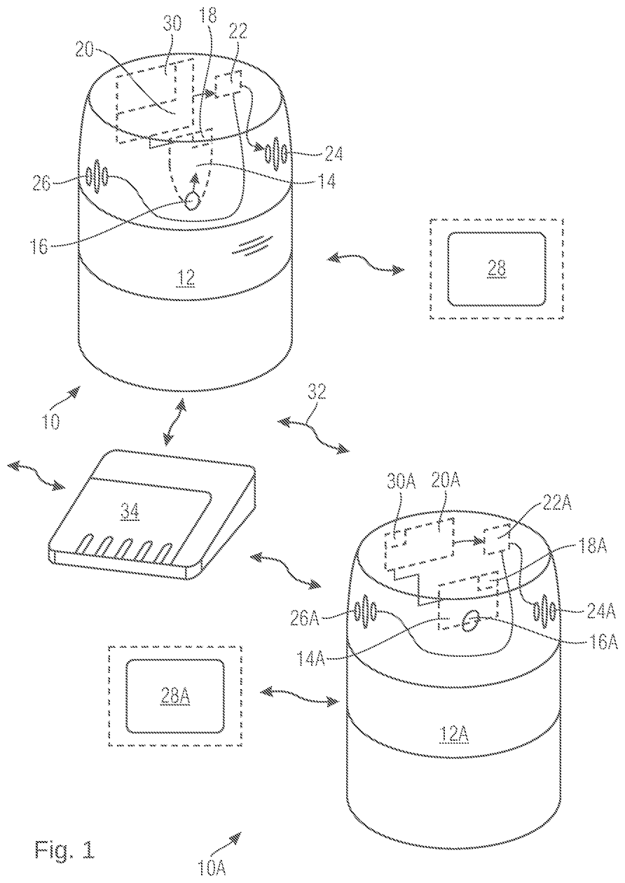

FIG. 1 shows an embodiment of a schematically depicted dental device which is capable of communicating with a further dental device.

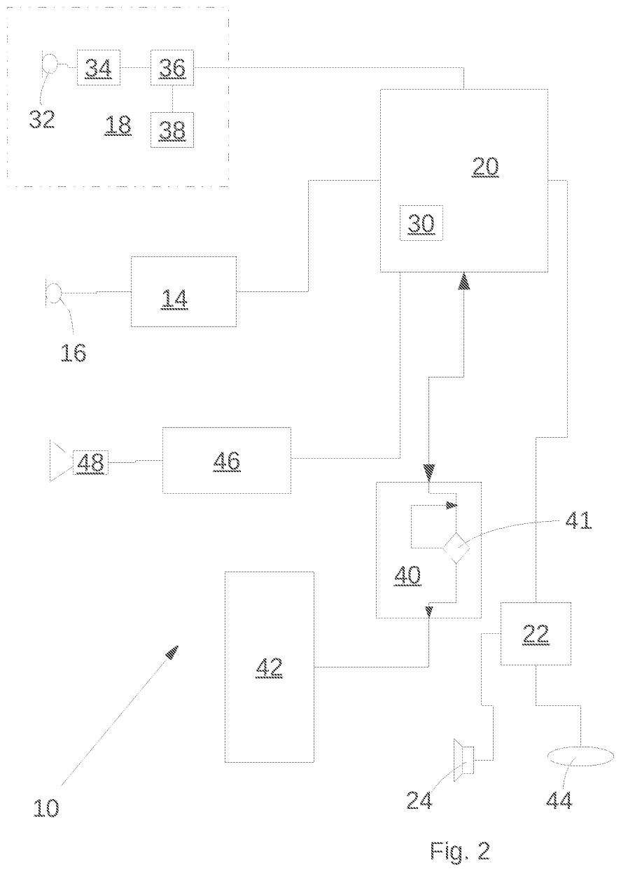

FIG. 2 shows a circuit diagram for an exemplary embodiment of the control device according to the invention and the other modules important for the invention.

### DETAILED DESCRIPTION

A dental device 10 is provided in FIG. 1, which is designed as a dental milling machine.

The dental milling machine can form the CAM device of a CAD/CAM device. It can also be part of a milling center for dental technology.

The dental device 10 comprises a schematically indicated working space 12. Outside the working space 12, for example above or below it, a speech recognition module 14 is provided. The speech recognition module 14 is implemented by means of a combination of hardware and software.

The speech recognition module 14 includes a microphone 16. The microphone 16 continuously picks up voices and sounds from the environment. Its output signal is connected to an ND converter which digitizes the output signal.

The digital output signal is fed to a code word module 18, which is also housed in the speech recognition module 14.

The code word module 18 has speech recognition capabilities, but in a reduced manner. It is only capable of recognizing a code word and then signaling that.

The code word used is a word that is easily recognizable by a machine and does not occur in everyday speech. Preferably, the code word is predetermined, in the delivery language of the dental device 10, and can be changed in accordance with the user's choice, but not arbitrarily, but can be replaced by one of, for example, 5 other also suitable words.

When the code word has been recognized, the rest of the speech recognition module 14 is switched on or activated. If the speech recognition module 14 is already active, it is left active.

Subsequent words or phrases are interpreted by the speech recognition module 14 and the speech recognition module then attempts to recognize control words.

Control words are those words associated with a function of the dental device 10. The choice of such words is limited, but not such that only one word is associated with each function. Preferably, synonymous or similar words trigger the same function.

Examples can be found in the table below:

Dental oven

| Control | |
|---|---|
| word | Function |
| hotter | Turn on the heating |
| warmer | Turn on the heating |
| fire | Turn on the heating |
| cool | Switch off the heating and open the furnace hood later |
| Stop | Switch off the heating and open the furnace hood later |
| End | Switch off the heating and open the furnace hood later |

Dental milling machine

| Control | |
|---|---|
| word | Function |
| fine | Display selection of finishing programs |
| simple | Display selection of finishing programs |
| finish milling | Display selection of finishing programs |
| Start at 7 a.m. | Start the specified milling program at 7 a.m. |
| | the next day |
| Start 7 a.m. | Start the specified milling program at 7 a.m. |
| tomorrow | the next day |
| Milling 7 | Start the specified milling program at 7 a.m. |
| o'clock | the next day |

A code corresponding to the function of the dental device 10 to be triggered is fed by the speech recognition module 14 to a control device 20. The control device 20 programmatically controls the function of the dental device 10.

The control device 20 is connected to an output module 22. The output module 22 is able to output speech and has a speech synthesis unit for this purpose. It is connected to loudspeakers 24, 26 that convert the generated speech into sound.

Typically, the recognized function of the dental device 10 is confirmed again via the output module 22 and the loudspeakers 24 and 26.

The output module 22 is also connected to a touch screen 28, which is connected to the dental device 10 via WiFi or Bluetooth in the exemplary embodiment shown.

The generated words are displayed additionally or alternatively on the touchscreen 28.

Communication between touchscreen 28 and output module 22 is bidirectional. The output module 22 is also able to receive and forward user input and, for example, a confirmation from the user about the function to be executed. In this respect, the output module 22 could also be referred to as communication module 22.

Typically, the function in question is not initiated by the control device 20 until the user input has confirmed that the function in question is actually desired.

The control device 20 also has an AI module 30. The AI module is used, for example, to monitor the functions of the dental device 10 to be performed and to intervene if they do not make sense. It is also able to answer user questions and outputs the answers via output module 22.

In addition, it can perform certain operations over the Internet, such as ordering consumables. This is also initially output via the output module 22 and must be confirmed by the user via the touch screen 28.

In a modified embodiment not shown, a camera or other identification scanner (e.g., an iris scanner or a fingerprint scanner) is provided on the dental device 10 or connected to it. This scanner captures physical characteristics of the user. The AI module evaluates these and thus identifies the user.

The following is a list of exemplary communication options that can be provided by the AI module 30:

1. “Answer questions” communication option

User: IvoAI, how can the brightness value of e.max Ceram be increased?

IvoAI: By placing Opal Effect 4 or Deep Dentin directly on the wash or ZirLiner, the brightness value in the dentin range can already be increased from depth. Then layer these areas with dentin. (https://www.ivoclarvivadent.ch/de-ch/zahntechniker/ips-emax-ceram-Gebrauchsinformation—IPS e.max Ceram.pdf)

User: IvoAI, how can the cervical depth effect of e.max Ceram be increased?

IvoAI: Use the Cervical Transpa masses with slightly higher fluorescence to complete the layering in the cervical third—e.g., CT orange-pink. (https://www.ivoclarvivadent.ch/de-ch/zahntechniker/ips-emax-ceram-Gebrauchsinformation—IPS e.max Ceram.pdf)

User: IvoAI, how long is temperature calibration still valid?

IvoAI: The next temperature calibration should be done in two weeks.

User: IvoAI, is your software up to date?

IvoAI: Yes, my software, version 1.23, is up to date.

User: IvoAI, is any training on intraoral scanners available?

IvoAI: Yes, the next online training on PrograScan Intraoral scanners will take place on March 9th at 10:00 am. The first training is free of charge. Should I register you “John Doe”?

User: Yes.

IvoAI: The registration has been carried out; the date has been entered in your calendar.

User: IvoAI, what can be printed with the Ivoclar 3D printer?

IvoAI: The PrograPrint system supports the indications: veneers, occlusal veneers, inlays, onlays, partial crowns, crowns, bridges, occlusion-supported splints, drilling templates and models.

User: And what parts does this system consist of?

IvoAI: The PrograPrint system consists of high quality materials (ProArt Print) as well as equipment for printing (PrograPrint PR5), cleaning (PrograPrint Clean) and post-exposure (PrograPrint Cure). The material tray (PrograPrint Pool), material cartridge (PrograPrint Cartridge) and building platform (PrograPrint Stage) are accessories. The print data is created with the 3Shape software “CAMbridge”, processed using the specially developed software “PrograPrint Manager” and transferred to the printer. All system components are optimally matched to each other and form a validated overall process.

2. “Execute functions” communication option

User: IvoAI, open Washbrand for e.max Ceram.

IvoAI: The firing program “IPS e.max Press layering technique—Washbrand” has been opened.

User: IvoAI, please clean.

IvoAI: Should I run self-cleaning?

User: Yes.

IvoAI: Self-cleaning has been started.

User: IvoAI, order Opal Effect masses.

IvoAI: Should I order a pack of IPS e.max Ceram Opal Effect masses from Ivoclar Vivadent?

User: Yes.

IvoAI: The order has been placed.

3. “Inform, recognize approach” communication option

Milling system “PrograMill”:

User: IvoAI, start the Doe job with e.max CAD.

IvoAI: Should I start the Doe job with the existing IPS e.max CAD Disc?

User: Yes.

IvoAI: The job has been started.

˜˜˜

The PrograMill recognizes the user's approach and informs independently, without prior user request.

IvoAI: The Doe job is completed. Now the objects have to be crystallized at the Programat.

˜

The dental furnace “Programat” recognizes the approach of the user and informs independently, without prior user request.

IvoAI: In coordination with PrograMill, the “Impulse/MO/Crystallization” program was opened for the Doe job.

User: Okay

All the user has to do is place the firing tray with the objects in the firing chamber and start the program.

The “Ivoclar Vivadent Assistant”, the PrograMill and the Programat are connected via “Ivoclar-Cloud”.

“PrograPrint” dental SL printing system:

User: IvoAI, start the John Smith job tomorrow morning so that it is ready at 7 o'clock.

IvoAI: Should I start the John Smith job with the appropriate start delay so that it is ready tomorrow at 7 o'clock?

User: Yes.

IvoAI: The job was started with a delay.

˜˜˜

The PrograPrint detects the user's approach the next morning and informs independently, without prior user request.

IvoAI: The John Smith job has been completed. Now the objects have to be cleaned for 3 minutes in the PrograPrint Clean. Conclusively, the objects must be finished with the program “ProArt Print Splint” in the PrograPrint Cure.

˜

With the simple PrograPrint Clean, the user positions the building platform with the objects in the holder, sets it for 3 minutes and starts the device.

˜

The PrograPrint Cure recognizes the user's approach and informs independently, without prior user request.

IvoAI: For the John Smith job the “ProArt Print Splint” program was opened.

User: Okay

The user only has to put the building platform with the objects in the finishing space and start the program.

In FIG. 1, a further, similar dental device 10A is provided, which corresponds to the dental device 10.

Both dental devices can communicate with each other via a Bluetooth connection 32. This makes it possible, for example, to optimize the work to be carried out and also to coordinate the timing.

Both dental devices 10 and 10A are connected to the Internet via a router 34 such as a Fritzbox. These connections can be realized via WiFi or LAN or in any suitable way. FIG. 2 shows a functional circuit diagram for an exemplary embodiment of the control device 14 according to the invention and the other modules of a stand-alone dental device 10 that are important for the invention.

These modules include the codeword module 18, which in this embodiment of the invention is formed separately from the speech recognition module 14. Accordingly, the codeword module 18 includes a separate microphone 32. Instead, it is also possible to use only a single microphone 16 and to connect this to either the codeword module 18 or the speech recognition module 14 by means of an analog switch.

The microphone 32 is connected to an analog/digital converter 34 in a manner known per se. This converts the output signal of the microphone 32 into a digital signal, in a manner known per se.

The sampling rate of the converter 34 is significantly lower than that of the analog-to-digital converter used in the speech recognition module 14. For example, the ratio of the sampling rates of the two converters may be 1:2, 1:4, or even 1:10. As a result, the data stream output by the converter 34 is significantly lower than in the speech recognition module 14. The data is now processed in a manner known per se, e.g. via FFT using a Viterbi algorithm.

In the illustrated embodiment example, a recognition 36 is performed according to the hidden Markov model. This accesses a database 38 which comprises only a small vocabulary compared to the corresponding database in the speech recognition module 14.

The codeword module 18 is switched on as soon as the dental unit 10 is switched on.

In contrast, the speech recognition module 14 is switched off at this time.

The output signal of the codeword module 18 is fed to the control device 20. It consists of only two states, namely active and inactive.

The “active” signal is output when the codeword module 18 has recognized the codeword. Once the control device 20 receives the “active” signal, it turns on the speech recognition module 14.

Once the speech recognition module 14 is powered up, it monitors and analyzes the signals received through the microphone 16.

This means, on the other hand, that a word corresponding to a particular control signal from the dental device will not trigger an action if it is spoken in the vicinity of the dental device, but before the code word has been said.

This behavior is highly desirable because it prevents a particular action of the dental device from being inadvertently triggered by the flow of speech in the environment.

In the speech recognition module 14, the received speech is continuously analyzed. If a word corresponding to a control command is recognized, a query, for example a request for confirmation, is output via the output module 22, if necessary. If the control command requires no further user input, it is transmitted by the control device 20 to the function module 40. This also comprises a rights module 41 for checking whether the recognized user has the rights to perform the desired function corresponding to the control command.

If the answer is in the affirmative, the function is permitted and forwarded to a heater 42 as an exemplary part of a dental device 10 configured as a dental furnace.

A speaker 24 and a display device 44 are connected to the output module 22. Through these, an interaction with the user takes place.

As a further means of interaction with the user, the control device 20 is connected to a camera 48 via an image recognition module 46.

The camera 48 is directed at the user, for example, so that identity recognition can be performed via the image recognition module 46.

However, the user may also perform gestures that the camera 48 can recognize. In this case, the image recognition module 46 is equipped for gesture recognition.

Further, the camera 48 may also be fed with a code that is recognized by the image recognition module 46. For example, a block of dental restorative material to be fired in the dental furnace may be provided with a QR code. This is held in front of the camera 48, which recognizes it and feeds it to the control device 20. The control device 20 then automatically selects the appropriate firing program for the block.

The image recognition module 46 can be used in addition to the voice recognition module 14. It may also be used alternatively. The codeword module 18 can also activate the image recognition module 46 instead of the speech recognition module 14, or both.

For the codeword module 18, the module LD3320 from the company Beaster can be used, for example, or an existing ASR software on a RaspberryPi. For the image recognition module 46 you can use e.g. the module NPD101 from Symbiant.

It is to be understood that instead of the dental milling machines shown here, other dental devices suitable for cooperation can also be used. An example of this is a dental stereolithography printer and an end-finishing device.

It is also possible to equip only one of the devices with the inventive intelligence and then to let the devices work according to the master-slave principle.

Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers.

A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

Where used herein, the term “non-transitory” is a limitation on the computer-readable storage medium itself—that is, it is tangible and not a signal—as opposed to a limitation on the persistence of data storage. A non-transitory computer-readable storage medium does not necessarily store information permanently. Random access memory (which may be volatile, non-volatile, dynamic, static, etc.), read-only memory, flash memory, memory caches, or any other tangible, computer-readable storage medium, whether synchronous or asynchronous, embodies it.

Although the invention is illustrated above, partly with reference to some preferred embodiments, it must be understood that numerous modifications and combinations of different features of the embodiments can be made. All of these modifications lie within the scope of the appended claims.

1. A dental device comprising a device selected from the group consisting of a dental furnace, a dental milling machine, a dental rapid prototyping device, a dental end-finishing device, a dental polishing device, a dental polymerization device, a dental CAD/CAM device, a dental extraction device, a dental mixer, a dental casting device, a dental press, a dental thermoforming device, a dental vibrator and other dental device, said dental device comprising
a speech recognition module,
a control device,
wherein the speech recognition module is connected to the control device, which control device controls at least a part of the functions of the dental device,
at least one microphone in the speech recognition module,
wherein the speech recognition module triggers a selected function of the dental device via the control device based on a recognition result,
an output module connected to the control device that outputs information about the triggered function,
wherein a code word module is provided which module continuously listens via the microphone,
wherein the code word module activates or leaves active the speech recognition module for speech recognition of further words when a code word is recognized, and
wherein the speech recognition module attempts to recognize the further words as predetermined control words or control commands each assigned to a function.

2. The dental device according to claim 1,
wherein the speech recognition module is switched off or deactivated as long as the code word module has not recognized a code word.

3. The dental device according to claim 1,
wherein the code word module has an analog/digital converter which operates with lower energy and/or lower sampling rate than an analog/digital converter of the speech recognition module.

4. The dental device according to claim 1,
wherein the code word module is implemented separately from the speech recognition module and is switched on when the dental appliance is switched on, and
wherein the speech recognition module is switched off as long as the code word module has not recognized a code word.

5. The dental device according to claim 1,
wherein the speech recognition module is integrated into the dental device and is in electrical connection with the control device of the dental device.

6. The dental device according to claim 1,
wherein the speech recognition module is spatially separated from the dental device and is or can be brought into data connection with the control device of the dental device.

7. The dental device according to claim 1,
wherein the speech recognition module is connected to the output module that acoustically and/or visually reproduces the recognized word or words.

8. The dental device according to claim 1,
wherein the speech recognition module is connected via an AI module to the output module, which acoustically and/or visually outputs responses to the recognized word or words, wherein the AI module is part of the control device or is realized in a cloud or other remote memory.

9. The dental device according to claim 1,
wherein the speech recognition module is connected to the Internet via an AI module or the speech recognition module accesses the AI module via the Internet, and
wherein the AI module or the speech recognition module or the control device triggers an action or an order, based on the recognized word or words.

10. The dental device according to claim 1,
wherein the speech recognition module is connected to the output module, which, based on the recognized word or words, acoustically or visually displays a selection of existing functions and prompts for selection from the selection of existing functions.

11. The dental device according to claim 1,
wherein the control device outputs, acoustically and/or visually, via the output module, information about the function the control device performs and/or is to perform.

12. The dental device according to claim 1,
wherein the control device outputs a selection or a question about functions executed and/or to be executed acoustically and/or visually via the output module and waits for a response from a user via the speech recognition module and triggers a function based on the recognized word or words.

13. The dental device according to claim 12,
wherein the control device stores a function to be started in the future based on the word or words recognized by the speech recognition module and starts the function at the correct time.

14. The dental device according to claim 1,
wherein the speech recognition module and/or the control device is connected by data connection to at least one other dental device having a control device.

15. A dental device comprising
a camera,
an image recognition module connected to a control device that controls at least part of the functions of the dental device,
an output module connected to the control device, and
a feedback device connected to the control device,
wherein the image recognition module recognizes a picture taken by the camera and triggers a selected function of the dental device via the control device based on the received recognition result, and
wherein the feedback device provides information about the triggered function via the output module.

16. The dental device according to claim 15,
wherein the image recognition module continuously records and recognizes images via the camera and unlocks rights when recognizing a particular image.

17. The dental device according to claim 15,
wherein the image recognition module activates or leaves active rights existing for a user to trigger functions of the dental device when recognizing a body part of the user.

18. The dental device according to claim 15,
wherein the image recognition module allows a user to perform at least one function of the dental device to which the user is entitled by recognizing temporally successive images and/or
wherein the speech recognition module allows a user to perform at least one function of the dental device to which the user is entitled by recognizing temporally successive words.

19. A method of activating a function of a dental device comprising a device selected from the group consisting of a dental furnace, a dental milling machine, a dental rapid prototyping device, a dental end-finishing device, a dental polishing device, a dental polymerization device, a dental CAD/CAM device, a dental extraction device, a dental mixer, a dental casting device, a dental press, a dental thermoforming device, a dental vibrator and other dental device, said method comprising
a code word module continuously listening via a microphone,
the code word module activating or leaving active a speech recognition module for speech recognition of further words when a code word is recognized,
the speech recognition module attempting to recognize the further words as predetermined control words or control commands each assigned to a function,
the speech recognition module triggering a selected function of the dental device via a control device based on a recognition result,
an output module connected to the control device outputting information about the triggered function.

20. A computer program product comprising program code which is stored on a non-transitory machine-readable medium, the machine-readable medium comprising computer instructions executable by a processor, which computer instructions cause the processor to perform the method according to claim 19.
